(19) United States
(12) Patent Application Publication
(10) Pub. No.: US 2001/0029471 A1
(43) Pub. Date: Oct. 11, 2001

(54) Product specifications modifying method and product specifications modifying system

(75) Inventor: Junichi Ito, Hachioji-shi (JP)

Correspondence Address: Strabu & Pokotylo, 1 Bethany Road, Building 6, Suite 83, Hazlet, NJ, 07730, US

(73) Assignee: Olympus Optical Co. , Ltd.;

(21) Appl. No.: 09/821,344

(22) Filed: Mar. 29, 2001

(30) Foreign Application Priority Data
Apr. 5, 2000 (JP) 2000-103630
Apr. 20, 2000 (JP) 2000-119994

(51) Int. Cl. G06F 17/60

(52) U.S. Cl. 705/26

(57) ABSTRACT

A method and a system with which the buyer can modify the specifications of a product so as to make it satisfy the needs of the buyer, while allowing mass production and maintaining the marketability of the product. With a product specifications modifying method and a product specifications modifying system according to the invention, the buyer prepares specifications modifying information for modifying the specifications of a product on the basis of an information preparing program made available to the buyer by buying the product and adapted to modify the specifications so as to satisfy his or her demand. Then, the buy modifies the specifications of the product on the basis of the specifications modifying information.

### CROSS-REFERENCE TO RELATED APPLICATIONS

This application is based upon and claims the benefit of priority from the prior Japanese Patent Applications No. 2000-103630, filed Apr. 5, 2000; and No. 2000-119994, filed Apr. 20, 2000, the entire contents of both of which are incorporated herein by reference.

### BACKGROUND OF THE INVENTION

This invention relates to a method and a system that can be realized typically by utilizing Internet. More particularly, the present invention relates to a product specifications modifying method and a product specifications modifying system for modifying the specifications of a product in order to meet the requirements of any buyer and make the product more satisfactory to the buyer.

Currently, the consumers' demand for products are highly diversified in various minute ways. For instance, some users who bought a personal computer paint the cabinet of the computer in order to make it special and easily identifiable, although the computer may be satisfactory to the user in terms of its features and performance.

In the case of costly products such as automobiles, there may be some that are customized (in terms of coloring and optional features in particular) to meet the requirements of the buyers.

Furthermore, there already exist methods and systems for modifying the specifications of a product to meet the specific requirements of the user who bought it.

Generally, the specifications of a product are defined to achieve a maximum satisfaction of a maximum number of buyers. For instance, for a product such as camera, the specifications (including the profile, the color and the functional features) of the product are defined on the basis of the presumed tastes of the expected buyers.

Under these circumstances, there are inevitably a number of consumers who are out of the scope of the maximum satisfaction of the maximum number of buyers projected by the manufacturer.

However, it is neither practical nor feasible to manufacture a wide variety of products to meet the minutely diversified demands of consumers from the viewpoint of economy and manufacturing efficiency. In fact, consumers are a mixture of those who are within the scope of the maximum satisfaction of the maximum number of buyers projected by the manufacturer and those who are out of it.

For instance, in the case of camera that is a relatively less costly product, it is neither practical nor feasible to sellers to provide each and every buyer with a camera that is exactly satisfactory to him or her from the viewpoint of economy and manufacturing efficiency as pointed out above. Additionally, it is not possible to accurately predict every type of camera that will be sold for sure.

Recently, there are systems with which buyers can place an order for a product with desired specifications by way of Internet.

For example, there are systems with which buyers can place an order for a motor bicycle, specifying the colors of the cowl, the frame and the tank. The company to which the applicant of the present patent application belongs has proposed a system for selling cameras with a computer program that allows the buyer to partly define the specifications.

However, some buyers may feel it cumbersome to use a personal computer and input specifications by operating the keyboard and/or other input devices.

### BRIEF SUMMARY OF THE INVENTION

In view of the above problems, it is therefore an object of the present invention to provide a method and a system with which the buyer can modify the specifications of an electronic appliance, which may be a camera, so as to make it satisfy the needs of the buyer, while allowing mass production and maintaining the marketability of the product. Another object of the present invention is to provide a method and a system with which the buyer can modify the specifications of an electronic appliance if the buy does not possess any personal computer and/or is not accustomed to use a personal computer.

In the first aspect of the invention, the above objects are achieved by providing a product specifications modifying system comprising an information preparing step for the buyer to prepare specifications modifying information for modifying the specifications of a product on the basis of an information preparing program made available to the buyer by buying the product and adapted to modify the specifications so as to satisfy his or her demand and a specifications modifying step for modifying the specifications of the product on the basis of said specifications modifying information prepared in said information preparing step.

In the second aspect of the invention, there is provided a product specifications modifying method comprising an information preparing step for the buyer to prepare specifications modifying information for modifying the specifications of a product on the basis of an information preparation program adapted to modify the specifications of the product so as to satisfy his or her demand, a transmission step for transmitting said specifications modifying information prepared in said information preparing step from the buyer to the supplier by way of a telecommunication line and a specifications modifying step for the supplier to modify the specifications of the product according to the specifications modifying information transmitted in said transmission step.

In the third aspect of the invention, there is provided a product specifications modifying method comprising an information preparing step for the buyer to prepare specifications modifying information for modifying the specifications of a product on the basis of an information preparation program adapted to modify the specifications of the product so as to satisfy his or her demand, an information recording step for recording said specifications modifying information on a predetermined recording medium, a sending step for sending said recording medium storing said specifications modifying information from the buyer to the supplier and a specifications modifying step for the supplier to modify the specifications of the product according to the specifications modifying information stored in said recording medium sent to the supplier in said sending step.

In the fourth aspect of the invention, there is provided a product specifications modifying method comprising an information preparing step for the buyer to prepare specifications modifying information for modifying the specifications of a product on the basis of an information preparation sheet made available to the buyer by buying the product and adapted to modify the specifications so as to satisfy his or her demand and a specifications modifying step for modifying the specifications of the product on the basis of said specifications modifying information prepared in said information preparing step.

In the fifth aspect of the invention, there is provided a product specifications modifying method comprising an information preparing step for the buyer to prepare specifications modifying information for modifying the specifications of a product on the basis of an information preparation sheet adapted to modify the specifications of the product so as to satisfy his or her demand, an information recording step for additionally recording said specifications modifying information on said information preparation sheet, a sending step for sending said information preparation sheet carrying said specifications modifying information from the buyer to the supplier and a specifications modifying step for the supplier to modify the specifications of the product according to the specifications modifying information recorded on said information preparation sheet sent to the supplier in said sending step.

In the sixth aspect of the invention, there is provided a product specifications modifying method comprising a step of manufacturing electronic appliances, a step of shipping said electric appliances with an information preparation sheet for preparing information for modifying the specifications thereof, a step of receiving any of said electronic appliances returned to the supplier from the buyer with the information preparation sheet prepared by the buyer, a step of reading the contents of said information preparation sheet, a step of modifying the returned electronic appliance according to the contents of said information preparation sheet and a step of shipping back the modified electronic appliance to the buyer.

In the seventh aspect of the invention, there is provided a product specifications modifying method comprising a step of buying an electronic appliance with an information preparation sheet for preparing information for modifying the specifications of said electronic appliance, a step of describing the specifications as modified to meet the demand of the buyer on the information preparation sheet according to the instructions shown thereon, a step of sending said electronic appliance to the supplier of the electronic appliance with the information preparation sheet describing the modified specifications and a step of receiving the electronic appliance as modified by the supplier according to the modified specifications described on said information preparation sheet.

In the eighth aspect of the invention, there is provided a product specifications modifying system comprising a processor, a memory for storing data and an activable program code, a buyer input unit for receiving the data input by the buyer, a display for displaying information to the buyer and a data base storing the information on a plurality of modifications made to the specifications of the camera bought by the buyer and the actual modifying operations corresponding to the modifications made to the specifications, upon being activated by the program code stored in said memory, the system displaying the requests for a plurality of modifications to be made to the specifications of the camera, receiving at least one of the modifications to be made to the specifications from the buyer, displaying the request for actual modifying operations to be carrier out corresponding to the modifications made to the specifications, receiving information on at least one of the actual modifying operations to be carried out from the buyer by way of the buyer input unit in order to redefine the camera so as to meet the demand of the buyer, the final specifications of the camera being determined on the basis of the modifications made to the specifications as received from the buyer and the information on the actual modifying operations as received from the buyer and conveyed to the buyer.

In the ninth aspect of the invention, there is provided a product specifications modifying system comprising a computer readable medium storing a computer operable program code including executable commands, upon being operated, said computer displaying the requests for a plurality of modifications to be made to the specifications of the camera, receiving at least one of the modifications to be made to the specifications from the buyer, displaying the request for actual modifying operations to be carried out corresponding to the modifications made to the specifications, receiving information on at least one of the actual modifying operations to be carried out from the buyer by way of the buyer input unit in order to redefine the camera so as to meet the demand of the buyer, the final specifications of the camera being determined on the basis of the modifications made to the specifications as received from the buyer and the information on the actual modifying operations as received from the buyer and conveyed to the buyer.

In the tenth aspect of the invention, there is provided a product specifications modifying system for defining a camera meeting the demand of the buyer, said system comprising a means for receiving information on the modifications to be made to the specifications of the camera and the actual modifying operations to be carried out corresponding to the modifications made to the specifications, a means for defining a camera meeting the demand of the buyer according to the modifications to be made to the specifications of the camera and the actual modifying operations to be carried out corresponding to the modifications made to the specifications, a means for specifying the data base for the modifications to be made to the specifications of the camera and the actual modifying operations to be carried out corresponding to the modifications made to the specifications for the purpose of defining the camera and a means for conveying the modified specifications of the camera to the buyer.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic block diagram of a first embodiment of product specifications modifying system for realizing a product specifications modifying method according to the invention;

FIGS. 2A and 2B are detailed flow charts of the first embodiment of product specifications modifying method according to the invention;

FIG. 3 is a schematic illustration of an image that can be displayed on the display screen of personal computer 7 in Step S102 of FIG. 2A;

FIG. 4 is a schematic illustration of an image that can be displayed on the display screen of personal computer 7 in Step S104 of FIG. 2A;

FIG. 5 is a schematic illustration of an image that can be displayed on the display screen of personal computer 7 in Step S112 of FIG. 2A;

FIG. 6 is a schematic illustration of an image that can be displayed on the display screen of personal computer 7 in Step S121 of FIG. 2B;

FIG. 7 is a schematic illustration of an image that can be displayed on the display screen of personal computer 7 in Step S125 of FIG. 2B;

FIG. 8 is a schematic block diagram of a second embodiment of product specifications modifying system for realizing a product specifications modifying method according to the invention;

FIG. 9 is a schematic block diagram of a third embodiment product specifications modifying system according to the invention;

FIG. 10 is a schematic illustration of part of a custom-made sheet that can be used for the third embodiment of product specifications modifying system; and

FIG. 11 is a schematic illustration of the remaining part of the custom-made sheet of FIG. 10.

### DETAILED DESCRIPTION OF THE INVENTION

Now, the present invention will be described by referring to the accompanying drawing that illustrates preferred embodiments of the invention.

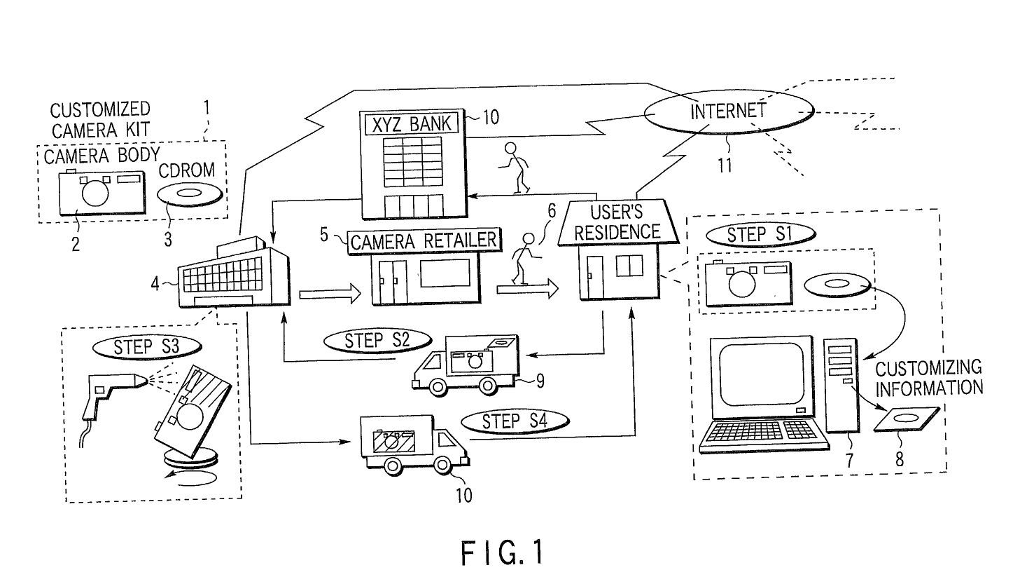

FIG. 1 is a schematic block diagram of a first embodiment of product specifications modifying system for realizing a product specifications modifying method according to the invention.

As shown in FIG. 1, manufacturer 4 manufactures cameras.

When marketing cameras, each buyer is provided with a customization program. Packaged camera kit 1 contains a camera body 2 and a CD-ROM 3 storing the customization program.

A CD-ROM 3 may be the most popular medium for storing the customization program. However, an electronic still camera comprises a memory card or a hard disk for recording picked up image data, it is also possible to store said customization program in such a recording medium.

Thus, packages containing the camera body 2 and the CD-ROM 3 will be sold by wholesale to camera retailers 5. If a camera buyer 6 who bought a customizing camera kit 1 from a camera shop 5 wants to modify some of the functional features and/or the design of the camera, he or she operates the customization program stored in the CD-ROM 3 that the buyer bought as part of the customizing camera kit 1 in a manner as will be described hereinafter. As a result, custom-made information is prepared to give instructions to the manufacturer 4 for modifying some of the functional features and/or the design of the camera.

Now, this procedure will be described in detail.

Firstly, the camera user 6 prepares custom-made information (Step S1). The camera user 6 runs the program stored in the CD-ROM 3 on a personal computer 7 and stores the prepared custom-made information on a floppy disk 8, although the recording medium for storing the custom-made information is not limited to a floppy disk 8 and any appropriate recording medium may be used so long as the manufacturer 4 can read the information therefrom.

Subsequently, the camera user 6 moves to a step of requesting the manufacturer 4 to modify some of the functional features and/or the design of the camera (Step S2). More specifically, the camera user 6 sends the floppy disk 8 and the camera body 2 to the manufacturer 4 by way of a forwarding agent 9 or by mail. If the manufacturer runs a service station in the vicinity of the residence of the camera user 6, the latter may directly bring it to the service station.

The camera user 6 has to pay the customizing expense to the manufacturer 4. The expense to be paid by the camera user 6 is automatically calculated according to the custom-made information when the customization program is run. Then, the camera user 6 pays the amount for covering the customizing expense to the account of the manufacturer 4 in a bank 10 specified by the manufacturer 4. Alternatively, the amount may be paid by way of a telecommunication network such as Internet 11. Additionally, the camera user 6 can transmit the custom-made information to the manufacturer 4 by way of Internet 11.

Thereafter, the manufacturer 4 works for the customization of the camera (Step S3). More specifically, after confirming that the amount covering the customizing expense has been paid to the account in the bank 10, the manufacturer 4 modifies the functional features and/or the design of the camera according to the custom-made information to make it meet the demand of the camera user 6. The operation of modifying the design and/or the features of the camera may be carried out by using the production line of the manufacturer 4. Then, the customized camera body 2 is sent to the residence of the camera user 6 by way of the forwarding agent 10 (Step S4). Alternatively, it may be sent to the service station of the manufacturer 4 and delivered to the camera user 6, or the customer, from the service station.

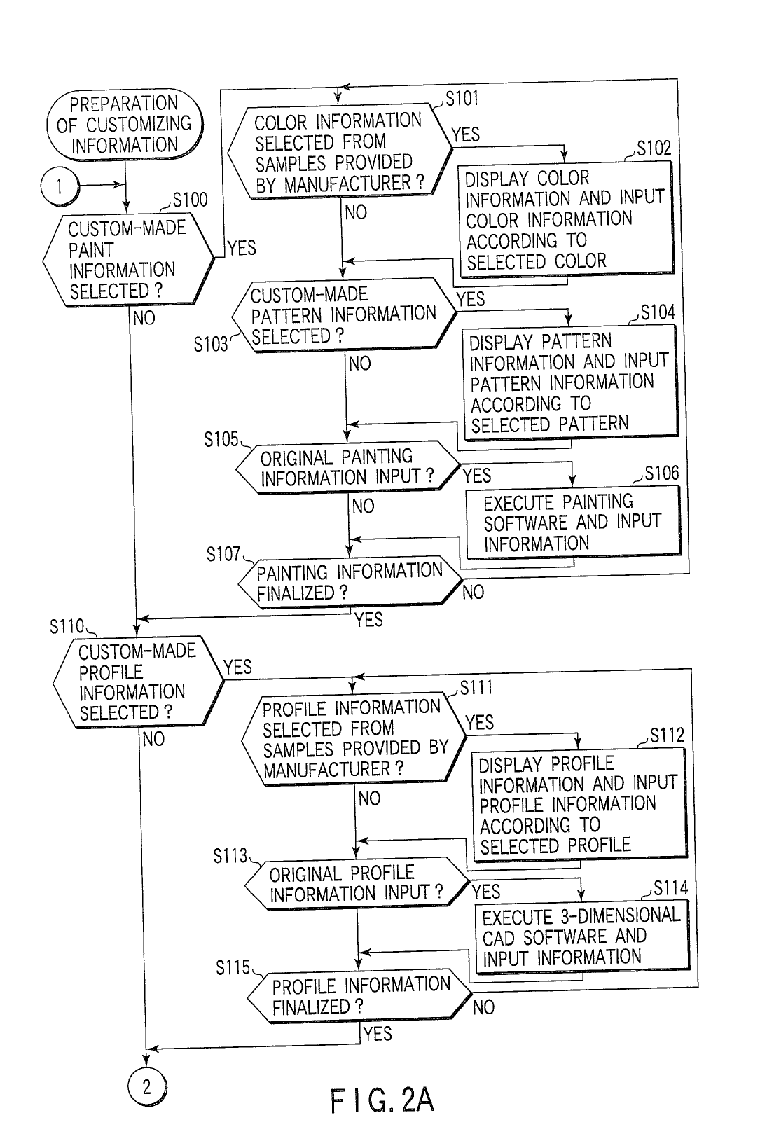

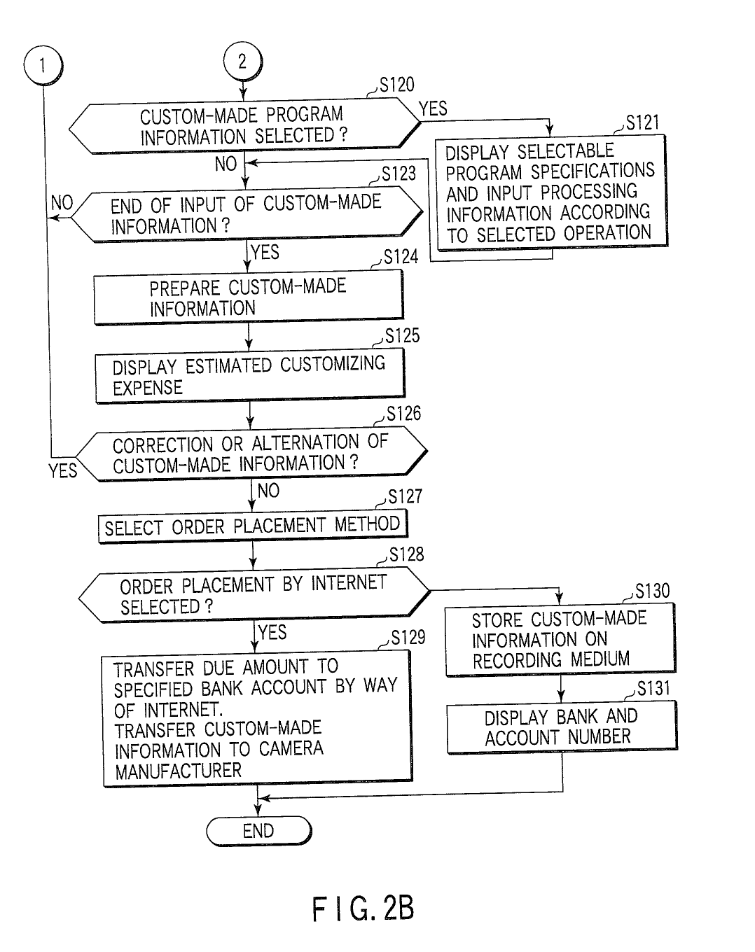

Now, the flow of operation according to the first embodiment of product specifications modification method will be described in detail by referring to the flow chart of FIGS. 2A and 2B.

As the CD-ROM 3 is loaded into the personal computer 7, the customization program starts. The custom-made information include custom-made painting information, custom-made profile information and custom-made program information.

Firstly, the system determines if the user wants to input custom-made painting information or not (Step S100). If it is determined that the user wants to input custom-made painting information, the system moves to Step S100, where the user is prompted to select desired colors from the color samples provided by the manufacturer 4 (Step S101). Then, the system moves to Step S102.

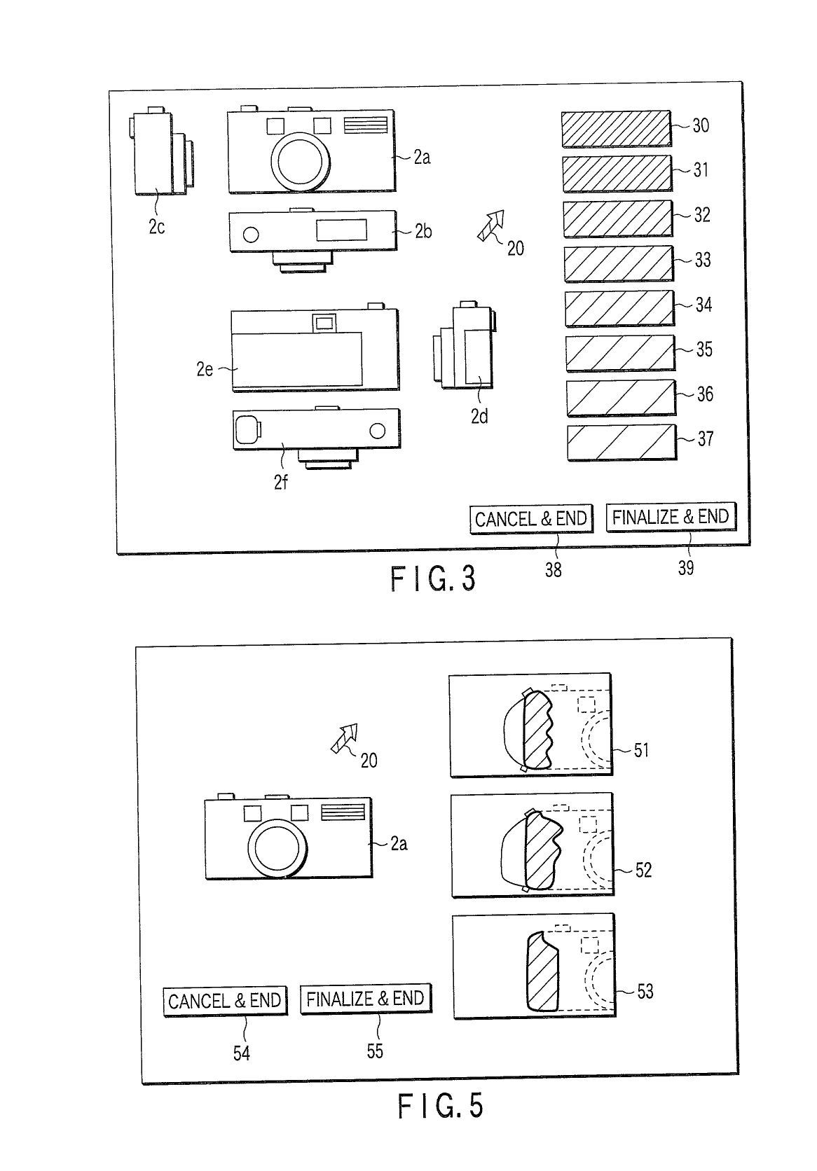

In Step S102, an image as shown in FIG. 3 is displayed on the monitor screen of the personal computer 7. In FIG. 3, reference symbols 2a, 2b, 2c, 2d, 2e and 2f denote respective surfaces of the camera body 2. Reference symbols 30 through 37 denote color boxes where the standard painting colors of the manufacturer 4 are shown.

The camera user 6 typically operates the mouse of the personal computer, which is a standard control device of the personal computer 7, to move the pointer 20 to the color box of the color he or she wants and selects the color on the screen. Then, the user 6 moves the pointer 20 to one of the surfaces 2a through 2f of the camera body 2, which he or she wants to be painted in the selected color. As the user 6 repeats this operation, the images of all the surfaces 2a through 2f are made to show the respective colors specified by the user 6. When the operation of forming a desired color image on the screen is completed, the user 6 selects “set & end” box 39 on the screen by means of the pointer 20 in Step S102 to finalize the custom-made information and end the operation in Step S102. If, on the other hand, the user 6 selects “cancel & end” box 38 on the screen, the custom-made information is not finalized and the operation ends.

Subsequently, the system determines if the user 6 wants to select a desired one of the pattern samples offered by the manufacturer 4 or not. If it is determined that the user wants to select a desired pattern sample (Step S103), the system proceeds to Step S104.

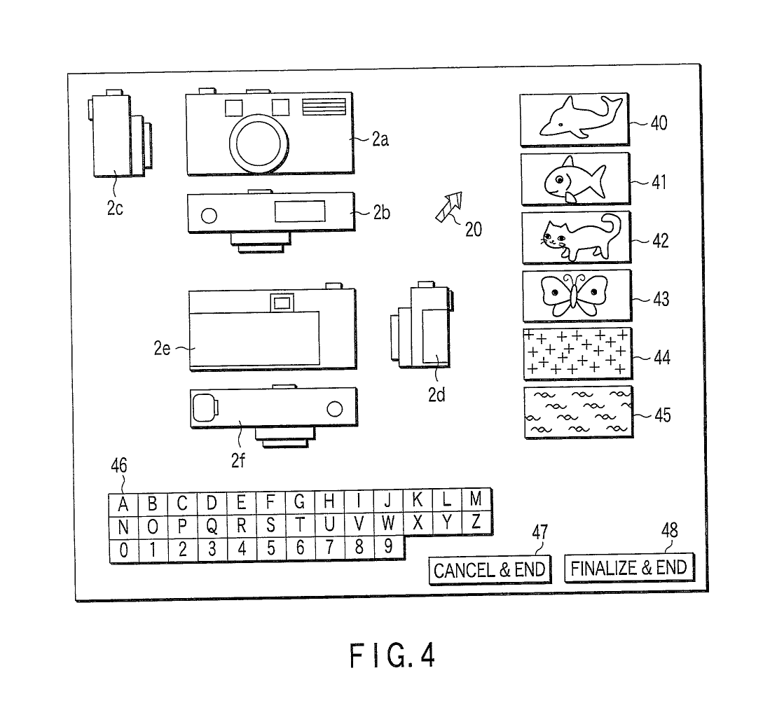

In Step S104, an image as shown in FIG. 4 is displayed on the monitor screen of the personal computer 7. Referring to FIG. 4, reference symbols 40 through 45 denote boxes showing standard patterns or designs that the manufacturer 4 can print. The camera user 6 operates the mouse of the personal computer to move the pointer 20 to the pattern box of the design he or she wants and selects the pattern on the screen. The user repeats this pattern specifying operation for all the surfaces he of she wants to be printed with the specified respective patterns out of the surfaces 2a through 2f of the camera body 2. As the user 6 repeats this operation, the images of all the surfaces 2a through 2f are made to show the respective patterns specified by the user 6.

If characters are to be printed on the camera body 2, the user 6 has to select the characters he or she wants from the alphanumeric boxes 46 by appropriately operating the mouse and moving the pointer 20. If the user 6 wants to finalize the selected requirements as custom-made information, the user 6 selects “set & end” box 48 on the screen by means of the pointer 20 in Step S102 to finalize the custom-made information and end the operation in Step S102. If, on the other hand, the user 6 selects “cancel & end” box 47 on the screen, the custom-made information is not finalized and the operation ends.

There may be cases where the camera user 6 cannot produce a desired camera image on the screen by combining any of the colors and the patterns provided by the manufacturer 4. If the user 6 wants to input original painting information, the system proceeds from Step S105 to Step S106, where a predetermined sequence of processing operations is executed on the basis of the painting software provided as part of the program stored in the CD-ROM 3.

Thus, the camera user 6 can produce a desired camera image by operating the program according to the painting software and prepare information necessary for painting the camera to make it show the desired image by using the colors and the patterns selected by the user 6.

However, it will be appreciated that the painting software is adapted to the type of the camera purchased by the camera user 6. Generally, painting software is designed for the user to prepare desired image data. Thus, the painting software is subjected to certain processing (manufacturing) restrictions when it is used for the operation of painting and printing the camera body 2. If the user wants to have the camera body 2 painted with delicate patterns, the extent of delicacy of painting cannot exceed the performance of the printing machine.

There may be colors that cannot be used for painting the camera body 2 if the camera user 6 wants them. Similarly, if the camera user 6 wants have the camera body 2 plated, it may sometimes be impossible to do so depending on the material of the camera body 2. Therefore, the processing operation of Step S106 will be conducted by taking such restrictions into consideration.

By moving through the above steps of Step S102, Step S104 and Step S106, the camera user 6 can input desired custom-made painting information.

Subsequently, the system determines if the painting information is finalized or not (Step S107). If it is determined that the painting information is finalized, the system proceeds to Step S110. If, on the other hand, it is determined that the painting information is not finalized, the system returns to Step S101 to repeat the above steps.

In Step S110, it is determined if the camera user 6 wants to prepare custom-made profile information or not. The system proceeds to Step S111 if it is determined that the camera user 6 wants to prepare custom-made profile information, whereas the system jumps to Step S120 if it is determined otherwise.

In Step S111, it is determined if the camera user 6 wants to select a profile from the profile samples provided by the manufacturer 4 or not. If the user wants to do so, an image as shown in FIG. 5 is displayed on the monitor screen of the personal computer (Step S112). The technique used for preparing custom-made profile information is similar to the one described above by referring to FIGS. 3 and 4. In other words, the camera user 6 operates the mouse to select the box of the desired profile by means of the pointer 20 on the display screen. Reference symbols 51, 52 and 53 denotes respective profiles of the grip that can be fitted to the camera body 2 as displayed on the screen. Therefore, the camera user 6 can select one of the displayed grips that has a desired profile by operating the mouse. Then, an image formed by synthetically combining the front image 2a of the camera and that of the selected grip is displayed on the monitor screen. As the camera user 6 selects the “finalize & end” box 55 on the screen, the selected information is finalized as custom-made information to end the operation. On the other hand, if the user 6 selects “cancel & end” box 54 on the screen, the custom-made information is not finalized and the processing operation of Step S112 ends.

The camera user 6 may not find the profile he or she wants in the profile samples provided by the manufacturer 4. Then, if the camera user 6 wants to input original profile information, the system proceeds from Step S113 to Step S114, where a predetermined sequence of processing operations is executed on the basis of the three-dimensional CAD software provided as part of the program stored in the CD-ROM 3. By carrying out a sequence of processing operations according to the software, the camera user 6 can prepare the desired profile of the camera grip and may additionally be able to have a pattern and/or characters engraved on part of the camera body 2.

However, it will be appreciated that the CAD software is one that is optimized to the type of the camera purchased by the camera user 6. Generally, CAD software is designed for the user to prepare desired profile data. Thus, the CAD software may be subjected to certain processing (manufacturing) restrictions when it is used for the operation of machining the camera body 2. If the user wants to have the camera body 2 machined to make it show a desired profile, such a profile may not be realized in some cases.

The may also be areas of the camera body 2 that should not be cut in order to maintaining the rigidity of the camera. If the user wants to cut the camera body 2 in any of such areas, it will not be allowed to do so. Therefore, the processing operation of Step S114 will be conducted by taking such restrictions into consideration.

By moving through the above steps of Step S112 and Step S114, the camera user 6 can input desired custom-made profile information.

Subsequently, the system determines if the custom-made profile information is finalized or not in Step S115. If it is determined that the profile information is finalized, the system proceeds to Step S120. If, on the other hand, it is determined that the profile information is not finalized, the system returns to Step S111 to repeat the above steps.

In Step S120, it is determined if the camera user 6 wants to prepare custom-made program information or not. The system proceeds to Step S121 if it is determined that the camera user 6 wants to prepare custom-made program information, whereas the system goes to Step S123 if it is determined otherwise.

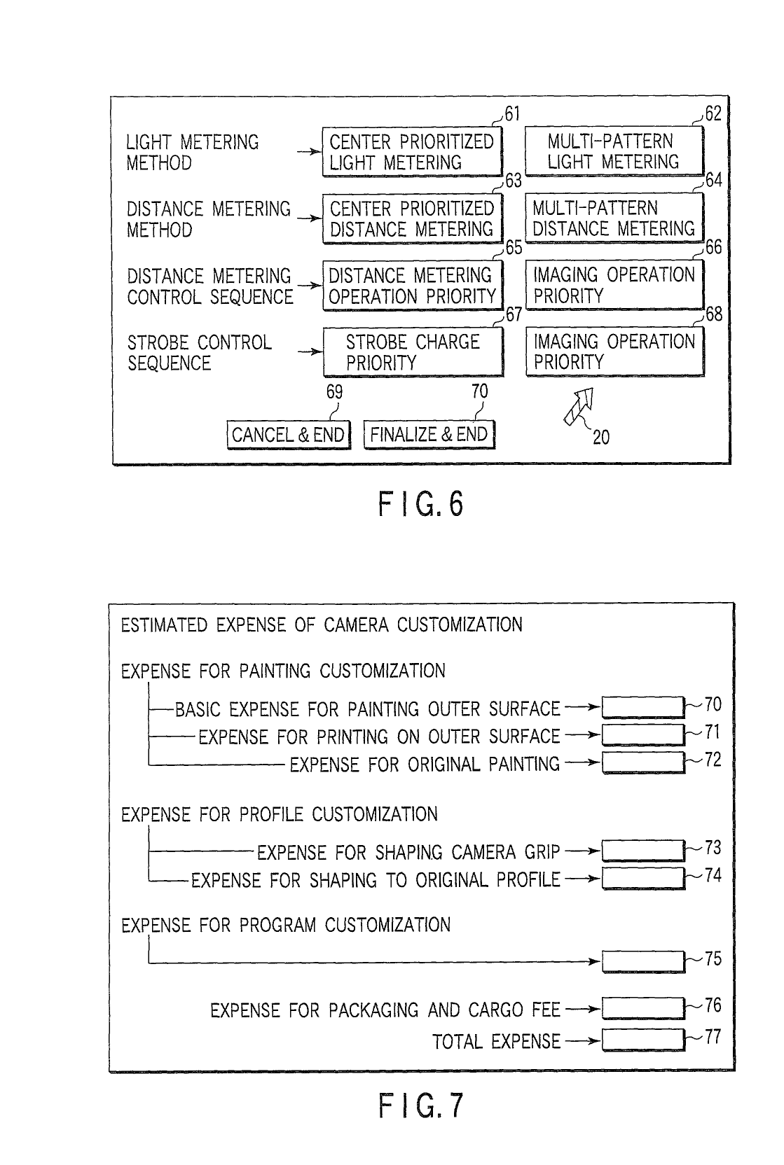

As the product operation proceeds to Step S121, an image as shown in FIG. 6 is displayed on the monitor screen of the personal computer 7.

The technique used for preparing custom-made program information is similar to the one described above by referring to FIGS. 3 through 5. In other words, the camera user 6 operates the mouse to select either “center prioritized light metering” box 61 or “multi-pattern light metering” box 62. For distance metering, either “center-only distance metering” 63 or “multi-pattern distance metering” box 64 may be selected. For the sequence of controlling the distance metering operation, either “distance metering operation priority” box 65 or “imaging operation priority” box 66 may be selected. If the distance metering operation priority box 65 is selected, no imaging operation can be realized until the on-going distance metering operation is terminated. If, on the other hand, the imaging operation priority box 66 is selected, the camera is so specified that an imaging operation can be carried out during the distance metering process.

For the strobe control sequence, either “strobe charge priority” box 67 or “imaging operation priority” box 68 may be selected. If the strobe charge priority box 67 is selected, no imaging operation can be realized until the strobe is made ready to emit light. If, on the other hard, the imaging operation priority box 68 is selected, the camera is so specified that an imaging operation can be carried out during the strobe charging process. Then, the camera user 6 selects “finalize & end” box 70 on the screen if he or she wants to finalize the custom-made information only by using the above choices. If, on the other hand, the camera user 6 does not want to finalize the custom-made only by using the above choices, he or she selects “cancel & end” box 69.

Then, in Step S123, the system determines if all the operation of preparing the custom-made information is completed or not. Then, the system proceeds to Step S124 if it is determined that all the operation of preparing the custom-made information is completed, whereas it returns to Step S100 if it is determined otherwise.

In Step S124, the system adds up all the pieces of custom-made information input by the camera user 6 and transforms then into custom-made information of a predetermined format that is transmitted to the manufacturer 4. Then, in Step S125, the expense required for the customization is computed and the result of the computation, or the breakdown of the expense, is displayed on the monitor screen of the personal computer 7.

FIG. 7 illustrates an image that can be displayed on the monitor screen as the breakdown of the expense.

Referring to FIG. 7, box 70 shows the expense corresponding to the custom-made information input in Step S102. Box 71 shows the expense corresponding to the custom-made information input in Step S104. Box 72 shows the expense corresponding to the custom-made information input in Step S106. Box 73 shows the expense corresponding to the custom-made information input in Step S112.

Similarly, box 74 shows the expense corresponding to the custom-made information input in Step S114. Box 75 shows the expense corresponding to the custom-made information input in Step S121. Box 76 shows the expense incurred when the manufacturer 4 sends the camera to the camera user 6. Box 77 shows the total amount to be paid by the camera user 6 to the manufacturer 4 for the customization. Therefore, the camera user 6 can change the custom-made information by referring to the amount he or she has to pay.

When the camera user 6 wants to change the custom-made information, he or she moves from Step S123 to Step S100 to repeat the above steps.

If, on the other hand, there is no need to change the custom-made information, the camera user 6 proceeds from Step S126 to Step S127. It will be convenient for the camera user 6 that the image of the estimated expense of FIG. 7 is always displayed during the operation of preparing custom-made information because the camera user 6 can always refer to the amount displayed there and the money he or she can afford to spend for the customization. In other words, it is desirable that the operation of preparing custom-made information and the display of the estimated cost are interlocked.

Then, in Step S127, the method of order placement is selected by the camera user 6. If the camera user 6 wants to place the order by Internet, he or she moves from Step S128 to Step S129. If, on the other hand, the camera user 6 does not want the user of Internet, the system proceeds to Step S130. In Step S129, the camera user 6 transfers the due amount to the account of the bank 10 specified by the manufacturer 4 and sends the custom-made information finalized in Step S124 to the manufacturer 4.

On the other hand, in Step S130, the custom-made information is recorded on floppy disk 8 and, in Step S131, the account number of the bank 10 to which the due amount has to be transferred for the expense of the customization is displayed to end the entire operation.

The program to be used for preparing custom-made information for a camera is stored in a CD-ROM 3 in the above described first embodiment. The camera body 2 and the CD-ROM 3 are packaged together.

However, with the above technique of selling cameras for customization, a CD-ROM 3 is sent to each and every camera user who does not want to customize his or her camera. Then, the CD-ROM 3 may have to be simply wasted. The second embodiment of the invention is devised to remedy this drawback so that the program is provided only to those camera users 6 who wants customization.

Now, the second embodiment of the invention will be described particularly in terms of distributing the program either by way of CD-ROMS 84 or by way of custom-made cards 3. Firstly, the use of CD-ROMs 84 will be described.

Camera customizing kits 80 sold by wholesale to camera retailers contain a camera body 81 and a user registration card 82. If the camera user 82 who bought a camera customizing kit 81 wants to customize the camera, he or she fills the blanks of the user registration card 82 and mails it to the manufacturer.

The blanks to be filled on the user registration cards 82 includes those for the type of camera, the camera ID number, the user's address, the user's E-mail address and the method of delivery of the program.

Upon receiving the registration card, the manufacturer 4 sends the customization program to the camera user 6 by the delivery method specified by the user. A CD-ROM 84 storing the program is mailed to user if the user wants one. An ID code is sent to the camera user 6 by E-mail if the user wants the program by way of Internet. If the camera user 6 received the ID code by way of Internet, he or she can download the customization program from the home page of the manufacturer 4. Alternatively, the ID code may be sent to the camera user 6 by mail (as indicated by reference symbol 83).

Thus, it may be clear from the above description that, according to the invention, any buyer can modify the specifications of an electronic appliance so as to make it satisfy the needs of the buyer, while allowing mass production and maintaining the marketability of the product.

Now, the third embodiment of the invention will be described.

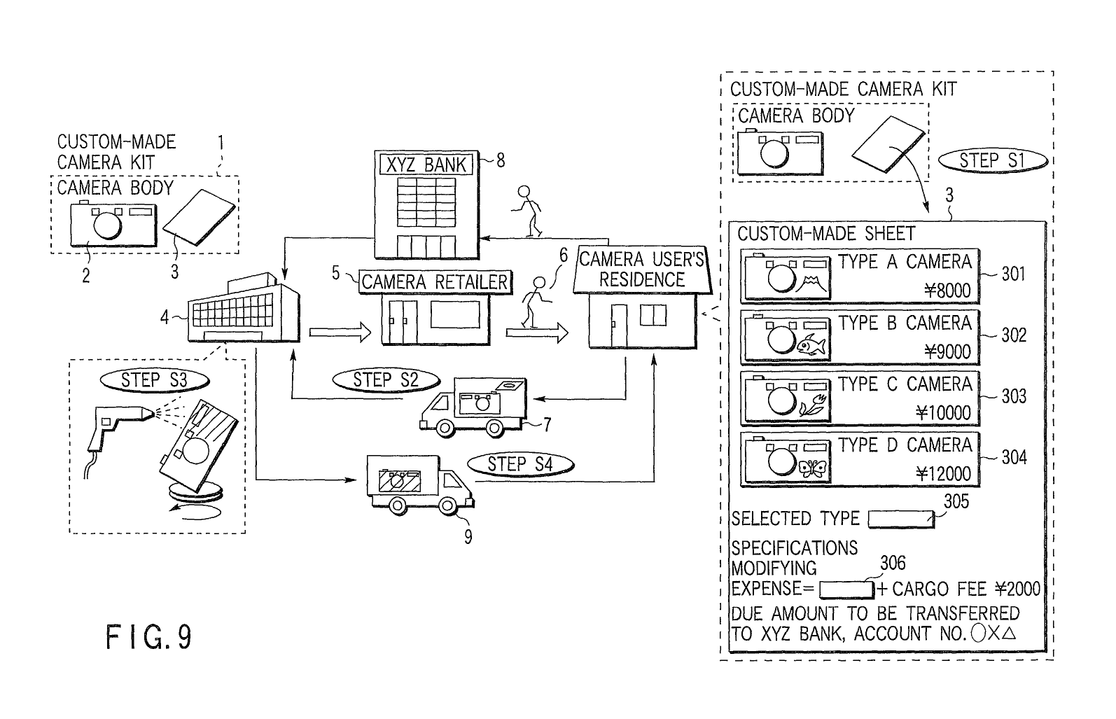

FIG. 9 is a schematic block diagram of a third embodiment product specifications modifying system according to the invention, which is a system for dealing with cameras. Referring to FIG. 9, manufacturer 4 manufactures camera bodies. For marketing camera bodies, the manufacturer 4 puts a camera body 2 and a custom-made sheet 3, which will be described hereinafter, into a same package 1 so that it may be delivered to buyer/user 6 together. The custom-made sheet 3 is used by the user 6 when he or she wants to modify the specifications of the camera. The custom-made sheet 3 is typically made of paper or plastic and predetermined information necessary for customizing the camera is printed thereon.

Packages containing a camera body 2 and a custom-made sheet 3 are sold by wholesale to camera retailers 5 as camera customizing kits. Assume that a user 6 who bought a kit wants to modify the design of the camera. Then, the camera user 6 can prepare custom-made information containing instructions to the manufacturer 4 for modifying the camera design.

In Step S1, the user 6 prepares custom-made information.

Also assume that the user 6 wants to customize the camera to show a desired design selected out of four candidate designs on the custom-made sheet 3.

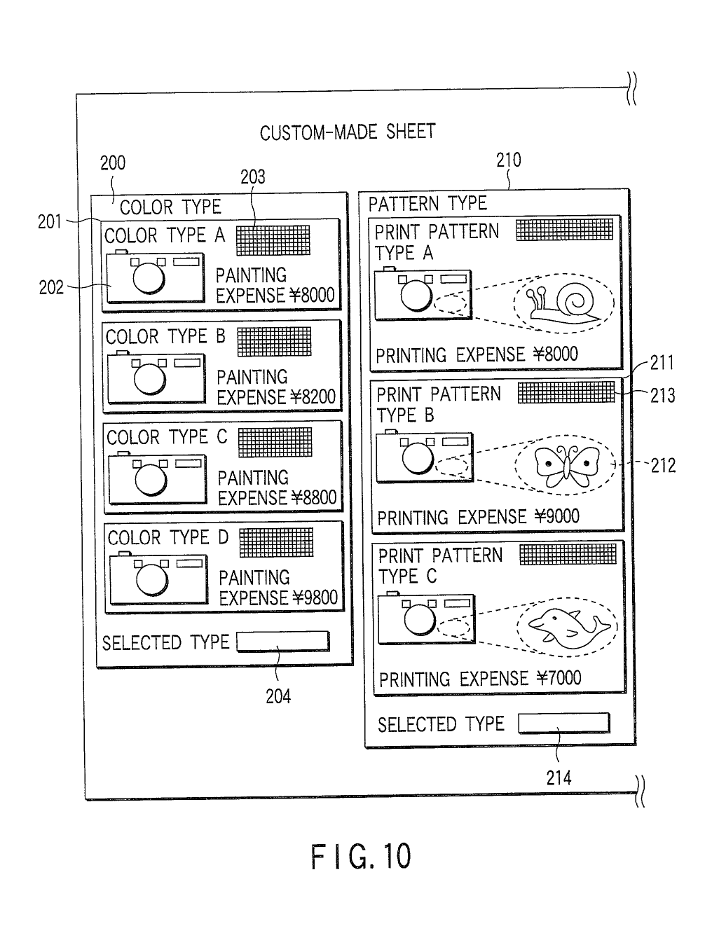

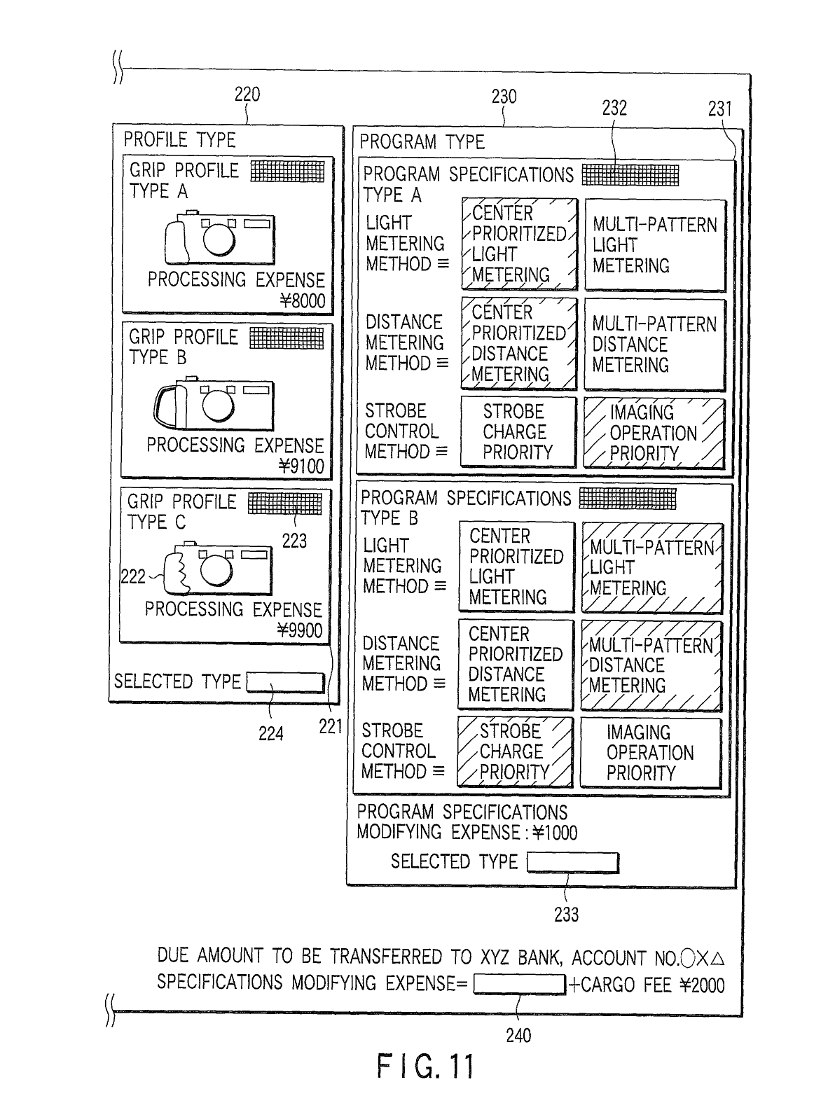

As a matter of fact, the custom-made sheet 3 shows four different camera designs including Type A 301, Type B 302, Type C 303 and Type D 304. The custom-made sheet 3 also shows the expenses necessary when the camera is modified to the respective designs (see FIGS. 10 and 11 for more detail).

The camera user 6 writes the camera type he or she selected in area 305 of the custom-made sheet 3. Additionally, the camera user 6 writes the expense incurred by the modification to area 306, which is the amount payable to the manufacturer 4. For the purpose of the invention, the information provided by the completed custom-made sheet 3 refers to custom-made information.

In Step S2, the user places an order for modifying the specifications of the camera 2 to the manufacturer 4. The camera user 6 can send the custom-made sheet 3 and the camera body 2 either by way of a forwarding agent 7 or by mail as shown by truck 9 in FIG. 9. If the manufacturer runs a service station or a retail shop in the vicinity of the residence of the camera user 6, the latter may directly bring it to there. The camera user 6 additionally has to pay the expense for modifying the specifications to the manufacturer 4. The user 6 do this by transferring the due amount to the account of the bank 8 specified by the manufacturer 4.

In Step S3, upon confirming that the due amount has been transferred to the account, the manufacturer 4 modifies the design of the camera 2 by painting it according to the information contained in the custom-made sheet 3 sent to the manufacturer 4. The operation of modifying the design of the camera may be carried out by using the production line of the manufacturer 4.

Then, in Step S4, the customized camera body 2 is sent to the residence of the camera user 6 by way of the forwarding agent or the 10 in a manner as represented by truck 9 in FIG. 9. Alternatively, it may be sent to the service station of the manufacturer 4 and delivered to the camera user 6, or the customer, from the service station or the retail shop 5.

While the illustrated example of custom-made sheet 3 of FIG. 9 is only adapted to modify the outer design of the camera 2, it may be so arranged that the user can modify other aspects of the camera for the convenience of the user 6.

FIGS. 10 and 11 show an alternative custom-made sheet, which represents an improvement to the custom-made sheet 3 of FIG. 9. The custom-made sheet 3 of FIGS. 10 and 11 is used to modify the color type, the pattern type, the profile type, and the program type. The specifications of the candidate color types are printed in area 200 on the custom-made sheet 3. For instance, the specifications of Color Type A are printed in area 201.

Area 202 on the custom-made sheet 3 shows a sample painted with Color Type A.

Area 203 on the custom-made sheet 3 is used for storing information necessary for painting the camera with Color Type A. The information may typically be expressed by means of bar codes and include information on the paint and the composition to be used for the painting. The manufacturer 4 paints the camera body according to the information stored in the area 203.

Area 204 on the custom-made sheet 3 is to be used by the user to put the color type he or she selected.

The patterns of the types that the camera user 6 can select are shown in area 210 on the custom-made sheet 3. For instance, the specifications of Pattern Type B are printed in area 211.

Area 212 on the custom-made sheet 3 shows a sample image of the pattern printed on the camera body when Pattern Type B is selected.

Area 213 on the custom-made sheet 3 is used for storing information necessary for printing the camera with Pattern Type B. The user only needs to put the pattern type he or she selected in the area 214.

The specifications of the candidate profile types are printed in area 220 on the custom-made sheet 3. For instance, the specifications of Grip Profile Type C are printed in area 221.

Area 222 on the custom-made sheet 3 shows the profile of the grip to be fitted to the camera body when Grip Profile type C is selected.

Area 223 on the custom-made sheet 3 is a memory area for storing the profile data of the grip. The manufacturer molds the grip and fits it to the camera according to the data stored in this area.

Area 224 on the custom-made sheet 3 is to be used by the user to put the grip profile type he or she selected.

Area 230 on the custom-made sheet 3 shows the candidate types of operation control program of the camera. For example, area 231 shows the contents of Program Specifications Type A. If the user select Type A, the light metering method, the distance metering method and the strobe control method of the camera are defined in a manner as described below.

The light metering method is defined as “multi-pattern light metering”, which means that luminance is observed at a plurality of points of the object and the surrounding scene to be shot and an optimal exposure time is determined by the camera.

The distance metering method is defined as “multi-pattern distance metering”, which means that the distance between the camera and the object and the surrounding scene to be shot is observed at a plurality of points. Then, the camera controls the imaging lens on the basis of the distance metering data obtained for the point where the object is expected to be located.

The strobe control method is defined as strobe charge priority method, which means that the imaging operation is not realized until the strobe is ready for emitting light provided that the luminance of the object is low and the use of the strobe is required.

Area 233 is used for the user 6 to put the program type selected by him or her. The user can selects one or more than one candidate types for the color type, the pattern type, the profile type and the program type.

After entering the selected types, the user calculates the cost of modifying the specifications and puts the due amount in area 240.

The custom-made sheet 3 may be made of paper or plastic. If it is made of plastic, the information necessary for modifying the specifications may be stored in an electronic circuit which is formed in the memory area (e.g., area 203).

NATURE/VOL 393/JUN. 18, 1998 “Putting It on Plastic” describes an experiment of preparing an integrated circuit by using only plastic. Therefore, a memory can be formed on a plastic sheet to store various pieces of information by utilizing the known technology.

In fact, a huge volume of complex information that cannot be stored by using bar codes can be stored on a custom-made sheet if this technology is used.

Thus, with the above described third embodiment of product specifications modifying system according to the invention, a user who buys a product (camera) receives an information preparing sheet on which he or she can prepare information necessary for modifying the specifications of the product in order to have the product modified in such a way that it satisfactorily meet his or her demand. Then, the user can prepare information for instructing the manufacturer to modify the product by using the information preparing sheet and a multiple-choice type process. After completing the information preparing sheet, the user sends it to the manufacturer with the product and then the manufacturer modifies the product according to the information for modifying the product contained in the information preparing sheet and sends back the modified product to the user.

Therefore, with this system, the user is not required to possess and operate a personal computer. The user only needs to fill the information preparing sheet by using a multiple-choice type process for the purpose of modifying the product.

With the above described third embodiment of product specifications modifying system (see FIG. 9), the custom-made sheet 3 is contained with the camera body in the same package 1. Therefore, a custom-made sheet 3 is sent to each and every camera user who does not want to customize his or her camera. Then, the custom-made sheet 3 may have to be simply wasted. The fourth embodiment of the invention is devised to remedy this drawback so that a custom-made sheet 3 is provided only to those camera users 6 who wants customization.

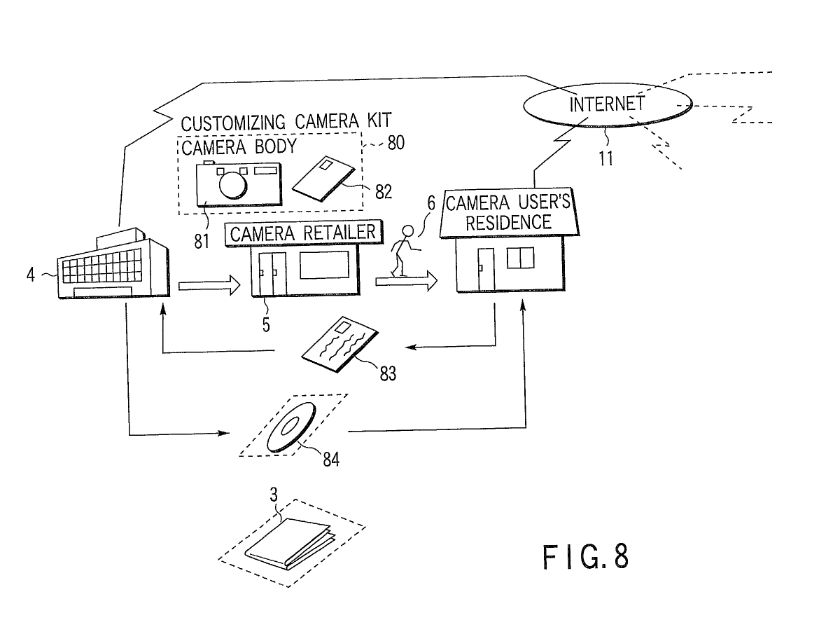

Now, the fourth embodiment of the invention will be described by referring to FIG. 8.

This embodiment is designed to eliminate the above drawback. While it is basically based on the third embodiment of system, it provides an improved method of distribution custom-made sheets.

Camera customizing kits 80 sold by wholesale to camera retailers contain a camera body 81 and a user registration card 82. If the camera user 6 who bought a camera customizing kit 81 wants to customize the camera, he or she fills the blanks of the user registration card 82 and mails it to the manufacturer.

Upon receiving the registration card 82, the manufacturer 4 sends a custom-made sheet to the camera user 6 by mail. If the user 6 can use Internet 11, he or she may send a request for receiving a custom-made sheet 3 by mail by way of the home page of the manufacturer 4. Alternatively, it may be so arranged that the user can print a custom-made sheet (form) 3 by him- or herself by way of the home page of the manufacturer 4.

With this method, if the user can operate a personal computer, he or she can obtain a custom-made sheet quickly by accessing the home page of the manufacturer so that it is not necessary for the manufacturer to put a custom-made sheets in all the packages of cameras in advance to a great advantage of cost saving.

If the buyers of a product are literate in terms of personal computer or not as a whole may be judged on the basis of the category of the users (in terms of generation, sex, hobbies, interest in personal computers, the relationship between the product and personal computers and so on).

Therefore, the technique of distributing custom-made sheets may be effective when most buyers are literate in terms of personal computer.

While the present invention is described above by referring to preferred embodiments, the present invention is by no means limited thereto and the described embodiments can be modified and/or altered in many different ways. For example, the present invention is not limited to the purpose of customizing cameras and may be applied to various electronic appliances.

For instance, any of the above described embodiments may be applied directly to the product if the product is a personal computer or a peripheral device thereof. Additionally, the above described embodiments may be modified in such a way that customizing information is prepared at the time of order placement.

Additionally, the multiple-choice type process may be provided to all the appropriate blanks to be filled by the user for preparing customizing information so that the user can prepare customizing information almost by simply putting check marks on the custom-made sheet.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A product specifications modifying method comprising:
an information preparing step for the buyer to prepare specifications modifying information for modifying the specifications of a product on the basis of an information preparing program made available to the buyer by buying the product and adapted to modify the specifications so as to satisfy his or her demand; and
a specifications modifying step for modifying the specifications of the product on the basis of said specifications modifying information prepared in said information preparing step.

2. A product specifications modifying method comprising:
an information preparing step for the buyer to prepare specifications modifying information for modifying the specifications of a product on the basis of an information preparation program adapted to modify the specifications of the product so as to satisfy his or her demand;
a transmission step for transmitting said specifications modifying information prepared in said information preparing step from the buyer to the supplier by way of a telecommunication line; and
a specifications modifying step for the supplier to modify the specifications of the product according to the specifications modifying information transmitted in said transmission step.

3. A product specifications modifying method comprising:
an information preparing step for the buyer to prepare specifications modifying information for modifying the specifications of a product on the basis of an information preparation program adapted to modify the specifications of the product so as to satisfy his or her demand;
an information recording step for recording said specifications modifying information on a predetermined recording medium;
a sending step for sending said recording medium storing said specifications modifying information from the buyer to the supplier; and
a specifications modifying step for the supplier to modify the specifications of the product according to the specifications modifying information stored in said recording medium sent to the supplier in said sending step.

4. The product specifications modifying method according to claim 2, wherein said information preparation program includes a program for evaluating the expense incurred by the modification to the product.

5. The product specifications modifying method according to claim 2, wherein said product is camera and said specifications modifying information include at least one of the information specifying the painting and the printing of the outer surface of the camera, information specifying the modification to be made to the profile of the camera and/or information specifying the modification to be made to the camera operation control program.

6. A product specifications modifying method comprising:
an information preparing step for the buyer to prepare specifications modifying information for modifying the specifications of a product on the basis of an information preparation sheet made available to the buyer by buying the product and adapted to modify the specifications so as to satisfy his or her demand; and
a specifications modifying step for modifying the specifications of the product on the basis of said specifications modifying information prepared in said information preparing step.

7. A product specifications modifying method comprising:
an information preparing step for the buyer to prepare specifications modifying information for modifying the specifications of a product on the basis of an information preparation sheet adapted to modify the specifications of the product so as to satisfy his or her demand;
an information recording step for additionally recording said specifications modifying information on said information preparation sheet;
a sending step for sending said information preparation sheet carrying said specifications modifying information from the buyer to the supplier; and
a specifications modifying step for the supplier to modify the specifications of the product according to the specifications modifying information recorded on said information preparation sheet sent to the supplier in said sending step.

8. The predetermined specifications modifying method according to claim 7, wherein
said product is camera and
said specifications modifying information include at least one of the information specifying the painting and the printing of the outer surface of the camera, information specifying the modification to be made to the profile of the camera and/or information specifying the modification to be made to the camera operation control program.

9. A product specifications modifying method comprising:
a step of manufacturing electronic appliances;
a step of shipping said electric appliances with an information preparation sheet for preparing information for modifying the specifications thereof;
a step of receiving any of said electronic appliances returned to the supplier from the buyer with the information preparation sheet prepared by the buyer;
a step of reading the contents of said information preparation sheet;
a step of modifying the returned electronic appliance according to the contents of said information preparation sheet; and
a step of shipping back the modified electronic appliance to the buyer.

10. A product specifications modifying method comprising:
a step of buying an electronic appliance with an information preparation sheet for preparing information for modifying the specifications of said electronic appliance;
a step of describing the specifications as modified to meet to the demand of the buyer on the information preparation sheet according to the instructions shown thereon;
a step of sending said electronic appliance to the supplier of the electronic appliance with the information preparation sheet describing the modified specifications; and
a step of receiving the electronic appliance as modified by the supplier according to the modified specifications described on said information preparation sheet.

11. A product specifications modifying system comprising:
a processor;
a memory for storing data and an activable program code;
a buyer input unit for receiving the data input by the buyer;
a display for displaying information to the buyer; and
a data base storing the information on a plurality of modifications made to the specifications of the camera bought by the buyer and the actual modifying operations corresponding to the modifications made to the specifications;
upon being activated by the program code stored in said memory, the system
(a) displaying the requests for a plurality of modifications to be made to the specifications of the camera;
(b) receiving at least one of the modifications to be made to the specifications from the buyer;
(c) displaying the request for actual modifying operations to be carrier out corresponding to the modifications made to the specifications;
(d) receiving information on at least one of the actual modifying operations to be carried out from the buyer by way of the buyer input unit in order to redefine the camera so as to meet the demand of the buyer,
(e) determining the final specifications of the camera on the basis of the modifications made to the specifications as received from the buyer and the information on the actual modifying operations as received from the buyer; and
(f) conveying the final specifications to the buyer.

12. A product specifications modifying system comprising:
a computer readable medium;
said medium storing a computer operable program code including executable commands,
upon being operated, said computer
(a) displaying the requests for a plurality of modifications to be made to the specifications of the camera;
(b) receiving at least one of the modifications to be made to the specifications from the buyer,
(c) displaying the request for actual modifying operations to be carried out corresponding to the modifications made to the specifications;
(d) receiving information on at least one of the actual modifying operations to be carried out from the buyer by way of the buyer input unit in order to redefine the camera so as to meet the demand of the buyer;
(e) determining the final specifications of the camera on the basis of the modifications made to the specifications as received from the buyer and the information on the actual modifying operations as received from the buyer; and
(f) conveyed the final specifications to the buyer.

13. A product specifications modifying system for defining a camera meeting the demand of the buyer, said system comprising:
a means for receiving information on the modifications to be made to the specifications of the camera and the actual modifying operations to be carried out corresponding to the modifications made to the specifications;
a means for defining a camera meeting the demand of the buyer according to the modifications to be made to the specifications of the camera and the actual modifying operations to be carried out corresponding to the modifications made to the specifications;
a means for specifying the data base for the modifications to be made to the specifications of the camera and the actual modifying operations to be carried out corresponding to the modifications made to the specifications for the purpose of defining the camera; and
a means for conveying the modified specifications of the camera to the buyer.
